(19) United States
(12) Patent Application Publication
(10) Pub. No.: US 2026/0162510 A1
(43) Pub. Date: Jun. 11, 2026

(54) BACKDRAFT DETERMINATION APPARATUS AND DETERMINING A LIKELIHOOD OF A BACKDRAFT IN AN ENCLOSURE

(71) Applicant: Government of the United States of America, as represented by the Secretary of Commerce, Gaithersburg, MD (US)

(72) Inventors: Ryan Leon Falkenstein, Knoxville, MD (US); Thomas George Cleary, Chesapeake Beach, MD (US)

(21) Appl. No.: 19/104,078

(22) PCT Filed: Aug. 30, 2023
(86) PCT No.: PCT/US2023/031483

§ 371 Date: Feb. 14, 2025

Related U.S. Application Data
(60) Provisional application No. 63/402,111, filed on Aug. 30, 2022.

(51) Int. Cl. G08B 21/16; G01N 31/12

(52) U.S. Cl. CPC G08B 21/16; G01N 31/12

(57) ABSTRACT

A backdraft determination apparatus for determining a likelihood of a backdraft in an enclosure includes: a phi meter that includes a heated packed bed reactor and that receives the gas sample from the enclosure and measures a temperature, an oxygen concentration, a carbon dioxide concentration, and a flow rate of the gas sample. The heated packed bed reactor performs lean catalyst combustion of the gas sample and produces a lean combustion product from which local and global equivalence ratio are determined to provide the likelihood of backdraft in the enclosure.

### CROSS REFERENCE TO RELATED APPLICATIONS

This application claims the benefit of U.S. Provisional Patent Application Ser. No. 63/402,111 (filed Aug. 30, 2022), which is herein incorporated by reference in its entirety.

### STATEMENT REGARDING FEDERALLY SPONSORED RESEARCH

This invention was made with United States Government support from the National Institute of Standards and Technology (NIST), an agency of the United States Department of Commerce. The Government has certain rights in this invention.

### BRIEF DESCRIPTION

Disclosed is a backdraft determination apparatus for determining a likelihood of a backdraft in an enclosure from a gas sample, the backdraft determination apparatus comprising: a phi meter comprising a heated packed bed reactor and that receives the gas sample from the enclosure and measures a temperature, an oxygen concentration, a carbon dioxide concentration, and a flow rate of the gas sample; a heated packed bed reactor disposed in the phi meter and in fluid communication with the enclosure and in fluid communication with an excess oxygen supply and that receives the gas sample from the enclosure, receives excess oxidizer gas from the excess oxygen supply, performs lean catalyst combustion of the gas sample in the presence of the excess oxidizer gas, and produces a lean combustion product from the lean combustion of the gas sample; an excess oxygen supply in fluid communication with the heated packed bed reactor and that communicates excess oxidizer gas to the heated packed bed reactor; a condenser in fluid communication with the heated packed bed reactor and in fluid communication with a flow control unit and that receives the gas sample from the heated packed bed reactor, condenses water vapor in the gas sample, removes water vapor from the gas sample, produces a dry combustion product from the gas sample, and communicates the dry combustion product to the flow control unit; a flow control unit in fluid communication with the condenser and in fluid communication with a vacuum pump and that receives the dry combustion product from the condenser, regulates flow through the phi meter, and produces a flow control unit signal; a vacuum pump in fluid communication with the phi meter and in fluid communication with the flow control unit and that receives the dry combustion product from the flow control unit and fluidically drives flow of the gas sample into the heated packed bed reactor of the phi meter; a gas analyzer in fluid communication with the vacuum pump and in electrical communication with a backdraft analyzer unit and that receives the dry combustion product from the vacuum pump, measures an oxygen gas concentration and a carbon dioxide concentration in the dry combustion product, produces a gas analyzer signal that indicates the oxygen gas concentration and the carbon dioxide concentration in the dry combustion product, and communicates the dry combustion product to the backdraft analyzer unit; and the backdraft analyzer unit that receives an oxygen sensor signal from the oxygen sensor, receives a temperature sensor signal from the temperature sensor, receives the heated flow meter signal from the heated flow meter, receives the flow control unit signal from the flow control unit, receives the gas analyzer signal from the gas analyzer, determines the oxygen gas concentration in the gas sample from the oxygen sensor signal, determines a local equivalence ratio of the gas sample from the oxygen sensor signal, determines the temperature of the gas sample from the temperature sensor signal, determines the concentration of water vapor in the dry combustion product produced from the lean combustion of the gas sample by the heated packed bed reactor from the heated flow meter signal and the flow control unit signal, determines the oxygen gas concentration and the carbon dioxide concentration in the lean combustion product from the gas analyzer signal, determines the local equivalence ratio and a global equivalence ratio from the oxygen gas concentration and the carbon dioxide concentration in the lean combustion product, and determines a likelihood of backdraft in the enclosure from the oxygen gas concentration in the gas sample, the temperature of the gas sample, the concentration of water vapor in the dry combustion product, the oxygen gas concentration and the carbon dioxide concentration in the lean combustion product, the local equivalence ratio, and the global equivalence ratio.

Disclosed is a process for determining a likelihood of a backdraft in an enclosure with a backdraft determination apparatus, the process comprising: receiving a gas sample from the enclosure; measuring the temperature, oxygen concentration, carbon dioxide concentration, and flow rate of the gas sample; performing lean catalyst combustion of the gas sample in presence of an excess oxidizer gas; condensing water vapor in the gas sample and removing water vapor from the gas sample; regulating flow through the phi meter; fluidically driving flow of the gas sample into the heated packed bed reactor of the phi meter; measuring the oxygen gas concentration and carbon dioxide concentration in the dry combustion product; determining the oxygen gas concentration in the gas sample; determining a local equivalence ratio of the gas sample; determining the temperature of the gas sample; determining the concentration of water vapor in the dry combustion product produced from the lean combustion of the gas sample by the heated packed bed reactor; determining the oxygen gas concentration and carbon dioxide concentration in the lean combustion product; determining the local equivalence ratio and a global equivalence ratio from the oxygen gas concentration and carbon dioxide concentration in the lean combustion product; and determining a likelihood of backdraft in the enclosure from the oxygen gas concentration in the gas sample, the temperature of the gas sample, the concentration of water vapor in the dry combustion product, the oxygen gas concentration and carbon dioxide concentration in the lean combustion product, the local equivalence ratio and the global equivalence ratio.

### BRIEF DESCRIPTION OF THE DRAWINGS

The following description cannot be considered limiting in any way. Various objectives, features, and advantages of the disclosed subject matter can be more fully appreciated with reference to the following detailed description of the disclosed subject matter when considered in connection with the following drawings, in which like reference numerals identify like elements.

FIG. 1 shows, according to some embodiments, a backdraft determination apparatus 200.

FIG. 2 shows, according to some embodiments, time-averaged temperature and gas mixture composition measurements of the 25.0 KW, 31.3 KW, and 37.5 KW methane fires as a function of fuel flow times at different positions within the compartment.

FIG. 3 shows, according to some embodiments, time-averaged temperature and gas mixture composition measurements of the 16.7 KW, 20.9 KW, and 25.0 KW propane fires as a function of fuel flow times at different positions within the compartment.

### DETAILED DESCRIPTION

A detailed description of one or more embodiments is presented herein by way of exemplification and not limitation.

Backdrafts are an extreme fire phenomenon that poses a life-threatening risk to anyone who may encounter them. A backdraft occurs in an isolated heated enclosure starved of oxygen with a substantial concentration of unburned fuel. When an opening is suddenly introduced into the enclosure, a gravity current of colder air is driven inward, mixing with the residing heated fuel. In the presence of an ignition source, a localized flammable mixture can ignite, deflagrate, and generate an extending flame and pressure wave through the enclosure's opening.

Firefighters rely on visual cues such as dark sooty smoke ‘puffing’ out from an interior around vents and door creases. Convention work focused on physical mechanisms of the backdraft and is limited in its output in that there is no systematic approach to evaluate the potential risk. Backdraft determination apparatus 200 and determining a likelihood of a backdraft in an enclosure with backdraft determination apparatus 200 overcome this paucity of information and backdraft determination apparatus 200 provides hardware and a binary logistic regression model that provides temperature and gas species composition measurements to predict the likelihood of a backdraft. Measurements include the global and local equivalence ratios and the temperature and oxygen concentration of sampled gas.

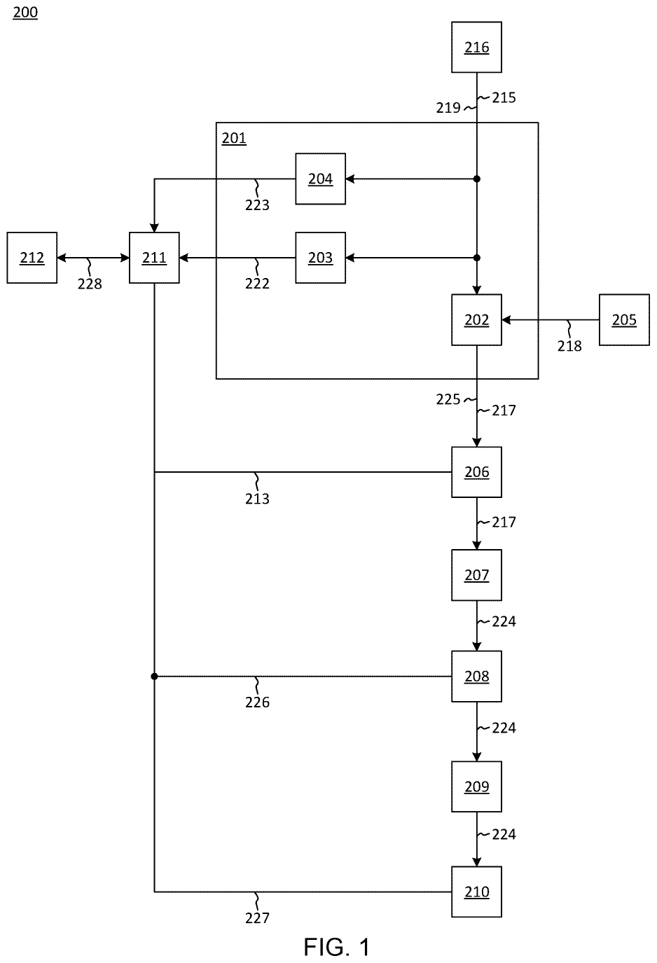

In an embodiment, with reference to FIG. 1, backdraft determination apparatus 200 for determining a likelihood of a backdraft in an enclosure includes: phi meter 201 that incudes heated packed bed reactor 202 and that receives gas sample 215 from enclosure 216 and measures a temperature, an oxygen concentration and a carbon dioxide concentration, and flow rate of gas stream gas sample 215; heated packed bed reactor 202 disposed in phi meter 201 and in fluid communication with enclosure 216 and in fluid communication with excess oxygen supply 205 and that receives gas sample 215 from enclosure 216, receives excess oxidizer gas 218 from excess oxygen supply 205, performs lean catalyst combustion of gas sample 215 in presence of excess oxidizer gas 218, and produces lean combustion product 217 from lean combustion of gas sample 215; excess oxygen supply 205 in fluid communication with heated packed bed reactor 202 and that communicates excess oxidizer gas 218 to heated packed bed reactor 202; condenser 207 in fluid communication with 206 and in fluid communication with 208 and that receives gas sample 215 from heated flow meter 206, condenses water vapor in gas sample 215, removes water vapor from gas sample 215, produces dry combustion product 224 from gas sample 215, and communicates dry combustion product 224 to flow control unit 208; flow control unit 208 in fluid communication with 207 and in fluid communication with 209 and that receives dry combustion product 224 from condenser 207, regulates flow through phi meter 201, and communicates dry combustion product 224 to vacuum pump 209; vacuum pump 209 in fluid communication with phi meter 201 and in fluid communication with flow control unit 208 and that receives dry combustion product 224 from flow control unit 208 and fluidically drives flow of gas sample 215 into heated packed bed reactor 202 of phi meter 201; gas analyzer 210 in fluid communication with vacuum pump 209 and in electrical communication with backdraft analyzer unit 211 and that receives dry combustion product 224 from vacuum pump 209, measures an oxygen gas concentration and a carbon dioxide concentration in dry combustion product 224, produces gas analyzer signal 227 that indicates the oxygen gas concentration and the carbon dioxide concentration in dry combustion product 224, and communicates dry combustion product 224 to backdraft analyzer unit 211; backdraft analyzer unit 211 that receives oxygen sensor signal 222 from oxygen sensor 203, receives temperature sensor signal 223 from temperature sensor 204, receives heated flow meter signal 213 from heated flow meter 206, receives flow control unit signal 226 from flow control unit 208, receives gas analyzer signal 227 from gas analyzer 210, determines the oxygen gas concentration in gas sample 215 from oxygen sensor signal 222, determines a local equivalence ratio of gas sample 215 from oxygen sensor signal 222, determines the temperature of gas sample 215 from temperature sensor signal 223, determines the concentration of water vapor in dry combustion product 224 produced from the lean combustion of gas sample 215 by heated packed bed reactor 202 from heated flow meter signal 213 and flow control unit signal 226, determines the oxygen gas concentration and the carbon dioxide concentration in lean combustion product 217 from gas analyzer signal 227, determines the local equivalence ratio and a global equivalence ratio from the oxygen gas concentration and the carbon dioxide concentration in lean combustion product 217, and determines a likelihood of backdraft in the enclosure 216 from the oxygen gas concentration in gas sample 215, the temperature of gas sample 215, the concentration of water vapor in dry combustion product 224, the oxygen gas concentration and the carbon dioxide concentration in lean combustion product 217, and the local equivalence ratio and the global equivalence ratio to determine the likelihood of backdraft in enclosure 216 from gas sample 215.

In an embodiment, backdraft determination apparatus 200 includes: oxygen sensor 203 disposed in phi meter 201 and in fluid communication with heated packed bed reactor 202 and in electrical communication with backdraft analyzer unit 211 and that receives gas sample 215 from enclosure 216, senses a concentration of oxygen gas in gas sample 215 received by heated packed bed reactor 202, produces oxygen sensor signal 222 that indicates the concentration of oxygen gas in gas sample 215, and communicates oxygen sensor signal 222 to backdraft analyzer unit 211.

In an embodiment, backdraft determination apparatus 200 includes: temperature sensor 204 disposed in phi meter 201 and in thermal communication with gas sample 215 and in electrical communication with backdraft analyzer unit 211 and that senses a temperature of gas sample 215 received by heated packed bed reactor 202, produces temperature sensor signal 223 that indicates the temperature of gas sample 215, and communicates temperature sensor signal 223 to backdraft analyzer unit 211.

In an embodiment, backdraft determination apparatus 200 includes: heated flow meter 206 in fluid communication with heated packed bed reactor 202 and in fluid communication with condenser 207 and in electrical communication with backdraft analyzer unit 211 and that receives lean combustion product 217 from heated packed bed reactor 202, measures total flow of lean combustion product 217 from heated packed bed reactor 202, produces heated flow meter signal 213 that indicates the total flow of lean combustion product 217, and communicates heated flow meter signal 213 to backdraft analyzer unit 211.

In an embodiment, backdraft determination apparatus 200 includes: control unit 212 in electrical communication with oxygen sensor 203, with temperature sensor 204, backdraft analyzer unit 211, heated flow meter 206, and flow control unit 208 and that controls operation of oxygen sensor 203, temperature sensor 204, backdraft analyzer unit 211, heated flow meter 206, and flow control unit 208.

In an embodiment, backdraft determination apparatus 200 the backdraft threshold is determined according to a binary logistic regression model that includes temperature, T̅, global equivalence ratio, φ̅ G, local equivalence ratio, φ̅ L, and oxygen concentration, X̅ₒ_{₂}, and measurements of lean combustion product 217. In an embodiment, binary logistic regression model includes a machine learning model to predict backdraft of enclosure 216. It is contemplated that the parameters, e.g., temperature, listed above can be real-time or time average measurements.

In an embodiment, backdraft determination apparatus 200 includes: enclosure 216 in fluid communication with heated packed bed reactor 202, in fluid communication with oxygen sensor 203 and in thermal communication with temperature sensor 204 and that comprises gas sample 215 and communicates gas sample 215 to heated packed bed reactor 202.

In an embodiment, backdraft determination apparatus 200 includes: gas sampling line 219 in fluid communication with enclosure 216, heated packed bed reactor 202, and oxygen sensor 203 and that communicates gas sample 215 from enclosure 216 to heated packed bed reactor 202 and to oxygen sensor 203.

In an embodiment, backdraft determination apparatus 200 includes: catalyst disposed in heated packed bed reactor 202 and that assists in complete combustion of gas sample 215 that comprises a fuel; and heating element disposed in heated packed bed reactor 202 and disposed on catalyst and in thermal communication with catalyst and that elevates the temperature of catalyst such that complete lean combustion of gas sample 215 occurs by heated packed bed reactor 202.

In an embodiment, backdraft determination apparatus 200 includes: outlet 225 disposed on phi meter 201 and in fluid communication with heated packed bed reactor 202 and in fluid communication with heated flow meter 206 and that communicates lean combustion product 217 from heated packed bed reactor 202 to heated flow meter 206.

The backdraft determination apparatus uses a phi meter that determines a likelihood of a backdraft or smoke explosion. The process for determining a likelihood of a backdraft in an enclosure includes: extracting a gas sample into an elevated temperature reactor via a vacuum mechanism in the sampling line; combusting an extracted gas sample using the elevated temperature reactor; measuring the flow, oxygen, temperature of the reactor's exhaust and inputting at least one quantifiable metric as a parameter into a logic regression model for which model coefficients are predetermined using an experimental dataset obtained from a series of backdraft experiments (e.g., as conducted in the NFRL at the NIST); and determining from the output of the logical regression model the probability for the presence of absence of conditions favorable to a backdraft. The quantifiable metric from the extracted gas sample includes the extracted gas temperature, the extracted gas concentration, the global equivalence ratio, the local equivalence ratio, or a combination comprising at least one of the foregoing factors. The quantifiable metric from the extracted gas sample also can include the reactor exhaust water and carbon dioxide concentration, or a combination comprising at least one of the foregoing factors. The process for determining a likelihood of a backdraft or smoke explosion can be a computer-implemented process.

The backdraft determination apparatus can be used when the potential of a backdraft or smoke explosion in an enclosure is suspected. After penetrating enclosure wall at an arbitrary location, a gas sample can be extracted via a phi meter equipped with a temperature and oxygen sensor at its inlet. The phi meter measures the global and local equivalence ratio and the concentration of the combusted extracted gas sample species. The phi meter can include a heated packed bed reactor, an excess air/oxygen supply line that feeds into the reactor, a heated flow meter, a condenser, an oxygen and carbon dioxide sensor, and a vacuum pump. Additionally, the inlet oxygen concentration measurement is required to obtain the local equivalence ratio.

During operation, gas samples are extracted into the phi meter via vacuum pump positioned at the end of the instrument's sampling line. Upon extraction, gas samples are fed into the phi meter's high temperature packed bed reactor. In the reactor, the extracted gas sample is introduced to an excess oxygen gas stream supplied from an oxygen reservoir. As the combined flow moves through the reactor, all existing fuel is combusted via lean combustion, as ensured by the high temperature of the reactor and combustion catalyst residing within reactor. The lean combustion results in an exhaust mainly comprised of oxygen, carbon dioxide, water vapor, and inert gases, (i.e., nitrogen and argon).

The exhaust flow of the reactor is measured using a heated flow meter, which prevents water vapor, generated from the combusted gas sample in the reactor, from condensing. Flow is then fed into a condenser, where is cools and dries the reactor exhaust flow, thus eliminating water from the combusted gas sample.

The dried sample is introduced to a flow controlling unit, oxygen and carbon dioxide sensors, and a vacuum pump, in no particular order. The flow controlling unit regulates the total flow through the phi meter's reactor, driven by the vacuum pump. The global and local equivalence ratios can be calculated through concentration and flow measurements.

During operation, measurements are recorded using a data acquisition system and reported to its user via control panel. The data acquisition system can also be remote or wireless. Operating conditions such as excess oxygen flow, total reactor flow, or reactor temperature can be adjusted using the control panel to modify the performance of the instrumentation.

The temperature, oxygen concentration, global and local equivalence ratios, and concentrations of the combustion products of the phi meter reactor can be used to predict the likelihood of a backdraft or smoke explosion within an enclosure using a binary logistic regression model. A binary logistic regression model has been implemented to demonstrate the predictive capability of backdraft or smoke explosion in an enclosure. Model coefficients are predetermined using an experimental dataset obtained from a series of backdraft experiments conducted in the National Fire Research Laboratory at the National Institute of Standards and Technology. The logistic regression model can be adjusted to account for sampling at multiple positions at carious heights in the enclosure of interest. The phi meter inputs the measurements into the model to obtain a probability that a backdraft occurs in the enclosure if an opening is presented. In its simplest form the apparatus includes the heated packed bed reactor, the excess air or oxygen supply line, the condenser, and the downstream flow control unit, oxygen sensor, and vacuum pump. Thus, the backdraft determination apparatus sole output is the global equivalence ratio, which can be used as the sole parameter in the model. Additional components can be included in the backdraft determination apparatus, such as the oxygen and temperature sensor at the inlet of the phi meter, the heated flow meter, and the downstream carbon dioxide sensor, which can improve the model accuracy when incorporated. Furthermore, the model's accuracy can be improved with the addition of simultaneous enhanced phi meter measurements made at different lateral heights in the enclosure of interest.

Backdraft determination apparatus 200 can be made of various elements and components that are fabricated or assembled together. Elements of backdraft determination apparatus 200 can be various sizes or shapes. Elements of backdraft determination apparatus 200 can be made of a material that is physically or chemically resilient in an environment in which backdraft determination apparatus 200 is disposed. Exemplary materials include a metal, ceramic, thermoplastic, glass, semiconductor, and the like. The elements of backdraft determination apparatus 200 can be made of the same or different material and can be monolithic in a single physical body or can be separate members that are physically joined.

A backdraft determination apparatus 200 is a device determines if a fire or post-fire condition, e.g., smoldering material or smoke, is creating a backdraft condition for an enclosure. A backdraft condition occurs when a fire burns most of the oxygen in a room, causing the pressure inside the room to drop. This can cause the fire to bring oxygen from outside of the enclosure, which can cause fire to spread rapidly and can cause an explosion hazard. Backdraft determination apparatus 200 can help firefighters identify backdraft conditions so that they can take steps to prevent them from happening. Backdraft determination apparatus 200 can be operated by firefighters. To use the apparatus, the firefighter places it in external to the enclosure where the fire is burning or has burned and connects backdraft determination apparatus 200 to the enclosure via gas sampling line 219. The firefighter turns on the apparatus and waits for it to measure the backdraft likelihood inside the enclosure. If the pressure inside the room drops below a certain threshold, the apparatus will alert the firefighter that a backdraft condition is occurring.

Backdraft determination apparatus 200 includes phi meter 201 that includes various components such oxygen sensor 203, temperature sensor 204, and heated packed bed reactor 202 disposed in a rugged housing that can be portable or maintained in a fixed location. Phi meter 201 can have a housing that protects the internal components. It can be a mounting point for components and can provide electrical connections to the components. Phi meter 201 can be made of a metal or plastic material that is resistant to corrosion and impact. Phi meter 201 can be sealed to prevent the ingress of water and other contaminants that are not sourced from enclosure 216 or excess oxygen supply 205. Phi meter 201 can include openings that allow for the passage of fluids, connectors, hoses, and electrical wiring. These openings can be located on the front, back, and sides of the enclosure. Phi meter 201 can include a number of features that protect or help operate the internal components of the apparatus. These features include a dust filter, fan, heat sink, and the like.

The heated packed bed reactor (HPBR) is used to heat the sample gas and promote the reaction between the sample gas and the catalyst. The HPBR can be a cylindrical vessel that can be made of stainless steel. The vessel can be filled with a packing material, such as ceramic beads or metal spheres. The packing material provides a large surface area for the sample gas to contact the catalyst. The catalyst can be a metal oxide, and can include a metal such as platinum, palladium, or rhodium. The catalyst promotes the reaction between the sample gas and the oxygen in the air and excess oxygen gas.

The HPBR is heated by an external heater. The temperature of the HPBR is controlled by a thermostat. The temperature of the HPBR can be from 500° C. and 1000° C. or any temperature suitable for lean combustion of the gas sample. The sample gas is introduced into the HPBR at the bottom of the vessel. The sample gas flows through the packing material and comes into contact with the catalyst. The reaction between the sample gas and the catalyst produces heat. The heat is transferred to the packing material and the walls of the vessel. The temperature of the HPBR increases. The HPBR can be used for lean combustion of various materials including those in gas phase, liquid phase, or solid phase. The pressure of the sample gas can be varied, e.g., from 1 atm to 100 atm. The flow rate of the sample gas can be varied, e.g., from 1 mL/min to 100 mL/min.

Oxygen sensor, e.g., oxygen sensor 203, measures the oxygen concentration in the pre-combustion gases. The oxygen concentration is an indicator of the status of the gas sample, and it can be used to determine whether or not the fire is in a backdraft condition. Oxygen sensor 203 produces an electrical current in response to the oxygen concentration in the surrounding environment. Oxygen sensor 203 can be calibrated to produce a specific voltage output for a given oxygen concentration. This voltage output can then be used to determine the oxygen concentration in the combustion gases. Oxygen sensor 203 can measure oxygen concentrations in a wide range of values. The typical range can be, e.g., from 0% to 21% oxygen. The sensor can also be calibrated to measure oxygen concentrations in other ranges, such as 0% to 10% oxygen or 10% to 21% oxygen. Oxygen sensor 203 is typically operated at a temperature of between 50° F. and 150° F. The sensor can also be operated at higher temperatures, but the accuracy of the measurements can be affected. In an embodiment, oxygen sensor 203 is incorporated at the inlet of the phi meter 201 upstream relative to heated packed reactor 202 to obtain the concentration of oxygen of gas sample 215. The oxygen concentration measurement obtained from oxygen sensor 203 can be used to determine a local equivalence ratio, a metric used in the model to determine the likelihood of backdraft.

Temperature sensor 204 measures the temperature of gas sample 215 in gas sampling line 219 and before receipt by heated packed bed reactor 202. Temperature sensor 204 can be a thermocouple or a resistance temperature detector (RTD). In an embodiment, temperature sensor 204 is disposed at the inlet of phi meter 201 upstream relative to heated packed bed reactor 202 to obtain the temperature of gas sample 215. The temperature measurement obtained from temperature sensor 204 can be used in the model to determine the likelihood of backdraft.

Excess oxygen supply 205 of backdraft determination apparatus 200 is a source of oxygen that is used to create an oxygen-rich environment in heated packed bed reactor 202. Excess oxygen supply 205 can be a variety of different types, including a compressed oxygen tank, a liquid oxygen tank, gaseous oxygen generator or air, e.g., compressed air or ambient air. The oxygen supply 205 is connected to heated packed bed reactor 202 by a conduit. The conduit can be a flexible hose, a rigid pipe, or a combination thereof. This oxygen-rich environment helps to ensure that the combustion process is complete and that there is no excess fuel in heated packed bed reactor 202. Excess oxygen supply 205 can be controlled by a control valve. The control valve is used to regulate the amount of oxygen that is supplied to heated packed bed reactor 202. The control valve can be a manual valve, an automatic valve, or a combination of the two. Various parameters of excess oxygen supply 205 and excess oxidizer gas 218 can be adjusted, including the flow rate of at which excess oxidizer gas 218 is supplied to heated packed bed reactor 202, the pressure at which excess oxidizer gas 218 is supplied to heated packed bed reactor 202, or the temperature that excess oxidizer gas 218 is supplied to heated packed bed reactor 202. In an embodiment, excess oxygen supply 205 is external to phi meter 201 and supplies a sufficient amount of oxygen to heated packed bed reactor 202 to ensure complete combustion of fuel in gas sample 215.

Heated flow meter 206 measures the flow rate of a fluid, e.g., lean combustion product 217 output from heated packed bed reactor 202. Heated flow meter 206 can include a heated section, a temperature sensor, and a flow sensor. The heated section can be a metal tube that is heated to a selected temperature. Fluid flows through the heated section, and the temperature sensor measures the temperature of the fluid. The flow sensor measures the velocity of the fluid, and the two measurements are used to calculate the flow rate. Heated flow meter 206 can measure flow rates from a few milliliters per minute to several liters per minute. The accuracy of the flow meter depends on the temperature of the fluid and the flow rate. There are several different types of heated flow meters available such as a thermal mass flow meter. This type of flow meter measures the change in temperature of the fluid as it flows through the heated section. Another type of heated flow meter is the thermal conductivity flow meter that measures the change in thermal conductivity of the fluid as it flows through the heated section. In an embodiment, heated flow meter 206 is made of stainless steel or other corrosion-resistant material. The heated section can be made of copper or brass, and the temperature sensor can be a thermocouple. In an embodiment, heated flow meter 206 is disposed downstream of heated packed bed reactor 202 and measures the total flow of lean combustion product 217. Heated flow meter signal 213, when compared to flow control unit signal 226 from flow control unit 208, determines the concentration of water vapor generated from combustion inside heated packed bed reactor 202, a metric used in the model to determine the likelihood of backdraft.

Condenser 207 is a heat exchanger that cools lean combustion product 217 from heated packed bed reactor 202 to condense water vapor or other selected condensable vapors. The condensed water or other selected condensable vapors can be collected in a condensate trap. It should be appreciated that condensation cools lean combustion product 217 until water vapor undergoes a phase change into a liquid. When lean combustion product 217 is cooled, the water vapor in lean combustion product 217 condenses and is removed. Condenser 207 is located downstream of heated packed bed reactor 202 and upstream of flow control unit 208. Condenser 207 can be a variety of different types, including but not limited to a shell and tube condenser, plate and frame condenser, air-cooled condenser, and the like. A shell and tube condenser is a heat exchanger that includes a cylindrical shell with a plurality of tubes running through it. Lean combustion product 217 flows through the tubes, and the cooling water flows around the tubes. The cooling water cools lean combustion product 217, and the condensed water or other selected condensable vapors are collected in the condensate trap. A plate and frame condenser is a heat exchanger that includes a series of plates that are arranged in a stack. Lean combustion product 217 flows through the spaces between the plates, and the cooling water flows through the plates. The cooling water cools Lean combustion product 217, and the condensed water and other condensable vapors are collected in the condensate trap. An air-cooled condenser is a heat exchanger that uses air to cool lean combustion product 217. Lean combustion product 217 flows through a series of fins, and the air is blown over the fins. The fins cool lean combustion product 217, and condensed water or other selected condensable vapors are collected in the condensate trap. Condenser 207 can be made of a corrosion-resistant material, such as stainless steel or aluminum. The cooling water for condenser 207 can be supplied from a variety of sources, such as a municipal water supply, a well, or a rainwater collection system. Condenser 207 can condense a wide range of water vapor or other selected condensable vapors. Condenser 207 can, e.g., condense water vapor at a temperature of up to 100° C. Condenser 207 can also condense other condensable vapors, such as methanol, ethanol, and acetone. Condenser 207 can be operated at a pressure, e.g., of 1 atm or greater. Condenser 207 can be operated at a temperature, e.g., of between 50° C. and 100° C. or any suitable to condense water vapor from lean combustion product 217. Condenser 207 can be operated at a flow rate, e.g., from 1 to 10 L/min or any suitable flow rate based on the flow of lean combustion product 217 from heated packed bed reactor 202. In an embodiment, condenser 207 is disposed downstream from heated flow meter 206 and condenses water vapor generated by heated packed bed reactor 202.

Flow control unit 208 is controls the flow of gas sample 215 and, optionally excess oxidizer gas 218 into heated packed bed reactor 202. Flow control unit 208 can include a valve, a regulator, and a controller, processor, and like components for control of fluid flow. The valve is a mechanical device that regulates the flow into heated packed bed reactor 202 and can be, e.g., a ball valve or a butterfly valve. The valve can be controlled by the controller. The regulator can maintain a constant or variable pressure of gas sample 215 in heated packed bed reactor 202. The regulator can be, e.g., a spring-loaded regulator or a diaphragm regulator. The regulator can be controlled by the controller. The controller can be an electronic device that controls the operation of the valve and the regulator. The controller can receive an input signal that is either remotely or internally sourced, e.g., input from oxygen sensor 203 or temperature sensor 204. The controller can use such input to determine an optimal flow of gas sample 215 into heated packed bed reactor 202. Flow control unit 208 can control the flow into heated packed bed reactor 202 over a range of values, e.g., from 0 to 100 cubic feet per minute (cfm). Flow control unit 208 can be operated at a pressure suitable for determining equivalence ratios with backdraft determination apparatus 200, e.g., from 5 to 10000 psi. Flow control unit 208 can be operated at a temperature from 26 to 200 degrees Centigrade. There are a variety of different types of flow control units 208 that can be used depending on the specific application. Some of the different types of flow control units 208 include ball valves, butterfly valves, spring-loaded regulators, diaphragm regulators, and the like. In an embodiment, flow control unit 208 is disposed downstream of condenser 207 and regulates the flow through phi meter 201. Flow control unit signal 226 of flow control unit 208, when compared to heated flow meter signal 213 from heated flow meter 206 determines the concentration of water vapor generated from combustion inside heated packed bed reactor 202, a metric used in the model to determine the likelihood of backdraft.

Vacuum pump 209 produces a vacuum or negative pressure relative to enclosure 216 in selected portions of backdraft determination apparatus 200 (e.g., heated flow meter 206, condenser 207, and the like) to create to backdraft likelihood in enclosure 216. Vacuum pump 209 can create a selected vacuum level to achieve sufficient operating conditions of backdraft determination apparatus 200. Vacuum pump 209 can be a rotary vane pump or a scroll pump. These types of pumps can operate at high speeds and generate a suitable relative negative pressure. Vacuum pump 209 can be powered by an electric motor, although it can also be powered by a gas engine or a hydraulic pump. Vacuum pump 209 can be connected to phi meter 201 and other elements of backdraft determination apparatus 200 by a suitable flow conduit, e.g., a hose or a pipe, at outlet 225. The hose or pipe withstands pressures created by lean combustion product 217 and the vacuum level generated by vacuum pump 209. Vacuum pump 209 can include a pressure relief valve to prevent the pressure from becoming too high in backdraft determination apparatus 200. In an embodiment, vacuum pump 209 is disposed downstream of condenser 207 and drives the flow of gas sample 215 that moves through phi meter 201.

Gas analyzer 210 measures the concentration of various gases in dry combustion product 224. It can measure the concentration of oxygen, carbon dioxide, carbon monoxide, and the like in dry combustion product 224 from heated packed bed reactor 202. Gas analyzer 210 provides gas composition data that is used to determine whether a backdraft condition exists. Gas analyzer 210 can have a display screen that shows the concentration of oxygen and carbon dioxide in dry combustion product 224, data logging unit that saves the data, and the like. Gas analyzer 210 uses a variety of sensors to measure the concentration of oxygen and carbon dioxide in dry combustion product 224. The sensors can be calibrated. Gas analyzer 210 can be operated or programmed with desired parameters. There are a variety of different types of gas analyzers 210 that can be used and can be selected for a particular application or needs of the user. Some of the factors that may be considered when choosing gas analyzer 210 include the range of concentrations that gas analyzer 210 can measure, the accuracy of gas analyzer 210, the cost of gas analyzer 210, and the ease of use of gas analyzer 210. Gas analyzer 210 can include components that individually measure separate compounds (e.g., an oxygen sensor, a carbon dioxide sensor, and the like), can be a universal detector such as a mass spectrometer that can include a residual gas analyzer, can be an infrared spectrometer, can be a chromatograph, and the like. Gas analyzer 210 can measure the concentration of various gases in dry combustion product 224, e.g., concentration of carbon dioxide, carbon monoxide, water vapor, or oxygen. Gas analyzer 210 can also measure concentration of other gases, such as nitrogen, hydrogen, and sulfur dioxide. It should be appreciated that the concentration of each gas in dry combustion product 224 can vary depending on the type of fuel that is being burned and conditions of the combustion process. The concentration of each gas in dry combustion product 224 can also vary depending on the severity of the backdraft condition. In an embodiment, gas analyzer 210 includes oxygen and carbon dioxide sensors disposed downstream of condenser 207 and determines oxygen and carbon dioxide concentrations of dry combustion product 224. The oxygen and carbon dioxide concentration measurements obtained from gas analyzer 210 can be used to determine a local and global equivalence ratios, metrics used in the model to determine the likelihood of backdraft.

Backdraft analyzer unit 211 can include a data acquisition and data analysis system that acquires and processes data from other elements of backdraft determination apparatus 200. Backdraft analyzer unit 211 can include a display that shows the results of a measurement or a determination (e.g., concentration of oxygen gas or carbon dioxide, an equivalence ratio, and the like) of likelihood of backdraft in enclosure 216. Backdraft analyzer unit 211 can interface with the various elements and read data or control such elements. In an embodiment, backdraft analyzer unit 211 is acquires and records data from all oxygen, carbon dioxide, and temperature sensors as well as flow units of backdraft determination apparatus 200.

Control unit 212 can be a microprocessor-based control unit that receives input signals from various sensors in backdraft determination apparatus 200 and generates output signals to control the operation of the apparatus and can be in communication with backdraft analyzer unit 211 to receive and communicate instrument data 228 that can be used to produce operational control parameters fed to elements of backdraft determination apparatus 200. Control unit 212 can perform various functions such as initializing the apparatus and performing self-tests, receiving input signals from the sensors, determining whether a backdraft condition exists, generating output signals to control the operation of the apparatus, and storing data and providing status information. Control unit 212 can include a printed circuit board (PCB) that contains a microprocessor, memory, and other electronic components. The microprocessor is the central processing unit of the control unit and executes a selected control algorithm. The memory stores the control program and other data. The other electronic components provide support functions such as input/output (I/O) and timing. There can be a number of different types of controllers can be used in control unit 212, and such can include a microprocessor-based control unit, a programmable logic controller (PLC)-based control unit, a dedicated control unit, and the like. In an embodiment, control unit 212 controls flow units, sensors, and other components use electrical power.

Heated flow meter signal 213 is a signal generated by heated flow meter 206 in response to flow of lean combustion product 217 through heated flow meter 206. Heated flow meter signal 213 is used to determine the backdraft condition of enclosure 216. Heated flow meter signal 213 signal can output a range of values depending on the flow rate of lean combustion product 217 through heated flow meter 206. Heated flow meter signal 213 can be a voltage signal that can be, e.g., from 0 to 5 volts. The amplitude of heated flow meter signal 213 can be proportional to the flow rate of lean combustion product 217 through heated flow meter 206. Heated flow meter signal 213 can be responsive to a number of operating parameters, including temperature of heated flow meter 206, pressure of lean combustion product 217 flowing through heated flow meter 206, humidity of lean combustion product 217 flowing through heated flow meter 206, and the like.

Backdraft threshold can be used to determine whether a backdraft condition is present in enclosure 216 or a likelihood of backdraft occurring in enclosure 216. Backdraft threshold can be a threshold value that is set by the user or can be preprogrammed into backdraft analyzer unit 211 or control unit 212. When backdraft analyzer unit 211 uses data acquired from various components of backdraft determination apparatus 200 in combination with backdraft threshold to indicate a likelihood of backdraft in enclosure 216, backdraft determination apparatus 200 can produce an alarm signal. Backdraft threshold can be set to a value sufficiently to cover be customized to the specific application in which it is being used.

Gas sample 215 is a sample of gases in enclosure 216 and is withdrawn from enclosure 216 by penetrating enclosure 216, e.g., with a piercing element of gas sampling line 219 or noninvasively acquiring gas from enclosure 216. Gas sampling line 219 is a conduit that extends from enclosure 216 to heated packed bed reactor 202 and communicates fluid there between. Gas sampling line 219 can be made of a metal or ceramic material that is resistant to the high temperatures and corrosive compounds present in gas sample 215. Gas sample 215 can include a composition of gases that can include, e.g., carbon dioxide, carbon monoxide, water vapor, oxygen, as well as a fuel. Gas sample 215 can include other gases, such as nitrogen, hydrogen, and sulfur dioxide. The concentration of each gas in gas sample 215 can vary depending on the type of fuel that is being burned and the conditions of the combustion process. Gas sample 215 is a hot gas with a temperature that can be from 1,000° F. to 3,000° F. Gas sample 215 can be corrosive and can damage materials that are not resistant to high temperatures and corrosive chemicals.

Enclosure 216 can be any structure in which a backdraft condition can exist.

Lean combustion product 217 is a gas composition produced by leanly combusting gas sample 215 by heated packed bed reactor 202 with a stoichiometric excess of oxidizer such as oxygen gas from excess oxidizer gas 218. Lean combustion product 217 can include a variety of gases, including carbon dioxide, carbon monoxide, hydrogen, nitrogen, and oxygen, and water vapor. The composition of lean combustion product 217 can vary depending on fuel in gas sample 215 and operating conditions of heated packed bed reactor 202. In lean combustion product 217, the stoichiometric ratio is the ratio of fuel to oxygen that is required to produce complete combustion.

Excess oxidizer gas 218 is used heated packed bed reactor 202 to completely combust fuel in gas sample 215. Accordingly, gas sample 215 is converted to lean combustion product 217 in presence of excess oxidizer gas 218. Excess oxidizer gas 218 can reduce risk of fire or explosion from the flammable mixture of gases in gas sample 215. It is contemplated that lean combustion product 217 can include a suitable oxidizer including oxygen gas, air, steam and the like.

Gas sampling line 219 is a conduit that carries gas sample 215 from enclosure 216 to heated packed bed reactor 202. Gas sampling line 219 can be made of a non-reactive material, such as stainless steel that does not contaminate gas sample 215. Gas sampling line 219 can be made of a material that is resistant to corrosion and abrasion. Gas sampling line 219 can be various sized and shapes, including having a diameter from ⅛ inch to ½ inch. A length of gas sampling line 219 can vary depending on the specific application. For example, gas sampling line 219 for a residential furnace can be a few feet long, while gas sampling line 219 for commercial boiler or office can be several hundred feet long. Gas sampling line 219 can be connected to heated packed bed reactor 202 at a point downstream of enclosure 216 and upstream from heated flow meter 206 so that gas sample 215 is communicated to heated packed bed reactor 202 in an absence of direct flow to heated flow meter 206. Gas sampling line 219 can be equipped with a flow meter to measure the flow rate of gas sampling line 219. Gas sampling line 219 is in communication with temperature sensor 204 to measure the temperature of gas sample 215. Gas sampling line 219 can be equipped with a pressure sensor to measure the pressure of gas sample 215. Gas sampling line 219 can be used at a temperature of between 0 degrees Fahrenheit and 1,000 degrees Fahrenheit or greater. Gas sampling line 219 can be operated at a pressure from 1 atmosphere to 10 atmospheres. Gas sampling line 219 can be either a straight conduit or a curved conduit. Gas sampling line 219 can be a single line or a multiple line. Gas sampling line 219 can also be a rigid line or a flexible line.

A catalyst is a substance that increases the rate of a chemical reaction without itself undergoing any permanent chemical change. In backdraft determination apparatus 200, catalyst is used to promote the oxidation of carbon monoxide (CO) to carbon dioxide (CO₂). This reaction is exothermic, meaning that it releases heat. The heat generated by the reaction can warm components of heated packed bed reactor 202. Catalyst can be a metal oxide that includes a catalytic element for oxidation such as platinum, palladium, or rhodium. These metals are highly efficient at catalyzing the oxidation of CO, and they are also resistant to corrosion. Catalyst can be coated onto a ceramic substrate, such as alumina or zirconia. This coating helps to protect the ceramic from the harsh conditions of the combustion chamber. Catalyst can be a finely divided powder with a high surface area. This allows it to come into contact with a large number of molecules, which increases the rate of the oxidation reaction. Other types of catalyst can be used and include zeolites, carbon nanotubes, and metal-organic frameworks. These catalysts offer different advantages and disadvantages, and the best type of catalyst for a particular application will depend on the specific requirements. Catalyst can be used to oxidize components of gas sample 215 in a presence of excess oxidizer gas 218 over a range of temperatures, e.g., from 500° C. to 3000° C. Catalyst can be used in a continuous-flow mode, wherein gas sample 215 contact catalyst in a steady stream. Catalyst can be installed in a ceramic honeycomb structure. The honeycomb structure provides a large surface area for the catalyst to come into contact with gas sample 215. Catalyst can be activated by heating it to a high temperature in the presence of excess oxidizer gas 218. This removes impurities from catalyst.

Heating element of heated packed bed reactor 202 can be a resistance heating element that is used to heat catalyst and gas sample 215. Heating element is made of a resistive material, such as nichrome, that has a high resistance to electrical current. When an electrical current is passed through heating element, the resistive material generates heat, which is transferred to catalyst and gas sample 215. Heating element can be located proximate to or in the center of phi meter 201 so that the heat is evenly distributed throughout heated packed bed reactor 202. Heating element can be controlled by a thermostat, which regulates the amount of electrical current that is passed through heating element. The thermostat can be set to a specific temperature, and heating element can automatically turn on and off to maintain the temperature of heated packed bed reactor 202 at that level. Alternatively, a temperature of heating element can be set by control unit 212 or backdraft analyzer unit 211. Heating element produces enough heat to ignite fuel in gas sample 215 and create a combustion reaction as well as maintain a selected temperature of heated packed bed reactor 202. Heating element can be operated at a variety of different power levels determined by the amount of electrical current that is passed through heating element. Heating element can be operated at a temperature of 500° C. to 1500° C. There are a variety of different types of heating elements 221 that can be used in backdraft determination apparatus 200 including a resistive heating element, an inductive heating element, a capacitive heating element, a thermoelectric heating element, a microwave heating element, and the like. The type of heating element that is used in backdraft determination apparatus 200 will depend on the specific application. Heating element can be include a resistive material, such as a nickel-chromium alloy that has a high resistance to electrical current.

Oxygen sensor signal 222 is an electrical signal generated by an oxygen sensor in response to the concentration of oxygen gas in a gas sample, e.g., gas sample 215. Oxygen sensors are used in a variety of applications, including automotive emission control systems, industrial process control, and medical devices. Oxygen sensor signal 222 can be a voltage signal that can be, e.g., from 0 to 5 volts. The voltage of oxygen sensor signal 222 is proportional to the concentration of oxygen gas in the gas sample. Oxygen sensor signal 222 can be a DC signal or an AC signal. The frequency of the AC signal can indicate the concentration of oxygen in the gas sample. The range of oxygen sensor signal 222 can depend on the type of oxygen sensor used. For example, a zirconia oxygen sensor typically has a range of outputs from 0 to 1 volt. A metal oxide semiconductor (MOS) oxygen sensor typically has a range of outputs from 0 to 5 volts.

Temperature sensor signal 223 can be a voltage signal that is generated by temperature sensor 204 in response to the temperature of gas sample 215. Temperature sensor signal 223 is used to backdraft likelihood for enclosure 216. Temperature sensor signal 223 can be a DC voltage signal that ranges from 0 volts to 5 volts. The voltage of temperature sensor signal 223 increases as the temperature of gas sample 215 increases. Temperature sensor signal 223 can be generated by a thermocouple, thermistor, and the like.

Dry combustion product 224 is produced by drying lean combustion product 217 with condenser 207 to remove water from lean combustion product 217.

Outlet 225 is a conduit that communicates lean combustion product 217 from heated packed bed reactor 202 to heated flow meter 206. Outlet 225 can be a cylindrical tube with a diameter of an appropriate size and shape to communicate lean combustion product 217 in an unobstructed manner and can be made of a corrosion-resistant material such as stainless steel or aluminum. Outlet 225 can be used to produce a range of outputs. Outlet 225 can be used to produce a low output for small heated packed bed reactor 202. Outlet 225 can also be used to produce a high output for large heated packed bed reactor 202. Outlet 225 can be adjusted to produce the desired output, e.g., by changing the diameter of outlet 225.

Flow control unit signal 226 is a signal generated by flow control unit 208 in response to flow of dry combustion product 224 through flow control unit 208. Flow control unit signal 226 is used to determine the backdraft condition of enclosure 216. Flow control unit signal 226 can include a range of values depending on the flow rate of dry combustion product 224 through flow control unit 208. Flow control unit signal 226 can be a voltage signal that can be, e.g., from 0 to 5 volts. The amplitude of flow control unit signal 226 can be proportional to the flow rate of dry combustion product 224 through flow control unit 208. Flow control unit signal 226 can be responsive to a number of operating parameters, including temperature of flow control unit 208, pressure of dry combustion product 224 flowing through flow control unit 208, humidity of dry combustion product 224 flowing through flow control unit 208, and the like.

Gas analyzer signal 227 is generated by gas analyzer 210 and indicates concentration of gas species in dry combustion product 224. Gas analyzer signal 227 is used to determine whether the likelihood of backdraft. Gas analyzer signal 227 can be a voltage signal, e.g., from 0 to 5 volts. The amplitude of gas analyzer signal 227 is proportional to the concentration of a specific compound in dry combustion product 224. Gas analyzer signal 227 can output a range of values and can provide indication as to which specific compound corresponds to the particular indicated concentration. There are a variety of different types of gas analyzer signals 227 that can include a thermal conductivity detector (TCD) signal, a flame ionization detector (FID) signal, an electrochemical detector (ECD) signal, a mass spectrometry (MS) signal, and the like.

Binary logistic regression model is a mathematical model that is used to predict the probability of an event occurring. In the context of backdraft determination apparatus 200, the event that is being predicted is whether or not a backdraft will occur in enclosure 216. Binary logistic regression model is based on a set of input variables, which are measurements of the conditions enclosure 216 as acquired by elements of backdraft determination apparatus 200. These variables include temperature, oxygen concentration, smoke density, carbon dioxide concentration, local equivalence ratio, global equivalence ratio, and the like. Binary logistic regression model uses these variables to calculate a probability of backdraft, which can be a value between 0 and 1. A value of 0 indicates that there is no likelihood of backdraft, while a value of 1 indicates that a backdraft is certain to occur, i.e., a high likelihood of backdraft. Binary logistic regression model can be implemented as a software program or instructions on computer readable medium or written into hardware components such as an FPGA. Binary logistic regression model takes the input variables as inputs and outputs the probability of backdraft as an output. Binary logistic regression model is trained on a dataset of historical backdraft events, e.g., those collated by the National Institute of Standards and Technology. The training data includes the values of the input variables for each event, as well as whether or not a backdraft occurred. The program learns the relationship between the input variables and the probability of backdraft by fitting a logistic regression model to the training data. Binary logistic regression model is a valuable tool for predicting the risk of backdraft. Binary logistic regression model can be used to identify situations where there is a high risk of backdraft and inform steps to take to mitigate that risk. Binary logistic regression model also can be used to train firefighters on how to identify and prevent backdrafts. Binary logistic regression model can be implemented in a suitable programming or scripting language, such as R, Python, Java, or C. The program runs on backdraft analyzer unit 211 or an external computer that includes a CPU, memory, and storage space. The amount of CPU, memory, and storage space that is used depends on the size of the training dataset.

Backdraft determination apparatus 200 can be made in various ways. It should be appreciated that backdraft determination apparatus 200 includes a number of optical, electrical, or mechanical components, wherein such components can be interconnected and placed in communication (e.g., fluid communication, optical communication, electrical communication, mechanical communication, and the like) by physical, chemical, optical, or mechanical interconnects. The components can be disposed on mounts that can be disposed on a bulkhead for alignment or physical compartmentalization. Elements of backdraft determination apparatus 200 can be formed from a suitable material to offer corrosion resistance and durability to high temperature.

In an embodiment, the logistic regression model determines the likelihood of backdraft or smoke explosion includes inputs such an experimental dataset obtained from experiments at the National Fire Research Laboratory at NIST. The model outputs a probability of a backdraft occurring in the enclosure of interest. The model uses measurements made from temperature, species concentrations, and flow measurements provided from additional components. The model is incorporated in the data acquisition system such that measurements recorded in real time are fed into the model to provide the user the likelihood of backdraft or smoke explosion when sampling. Phi meter 201 can be assembled with all sensors and components used for operation and gas sample components that facilitate the flow of the extracted sample and can interface with other components using high temperature-tolerant connectors. The heated packed bed reactor is packed with a catalyst that aids in the combustion of incoming fuel. An oxygen and temperature sensor are positioned and the inlet of the reactor, in addition to an excess air or oxygen gas line. The heating element is arranged in heated packed bed reactor 202 to ensure adequate temperatures for combustion of incoming gas samples. A heated flow meter is disposed at the outlet of heated packed bed reactor 202 and subsequently followed by condenser 207. A flow controlling unit, vacuum pump, and oxygen and carbon dioxide sensor are positioned downstream of the condenser in a selected arbitrary order. The data acquisition system and control panel are connected to measurements devices and components requiring power using electrical circuits to record data and maintain operation.

In an embodiment, a process for determining a likelihood of a backdraft in an enclosure with backdraft determination apparatus 200 includes: receiving a gas sample from the enclosure; measuring the temperature, oxygen concentration, carbon dioxide concentration, and flow rate of the gas sample; performing lean catalyst combustion of the gas sample in presence of an excess oxidizer gas; condensing water vapor in the gas sample and removing water vapor from the gas sample; regulating flow through the phi meter; fluidically driving flow of the gas sample into the heated packed bed reactor of the phi meter; measuring the oxygen gas concentration and carbon dioxide concentration in the dry combustion product; determining the oxygen gas concentration in the gas sample; determining a local equivalence ratio of the gas sample; determining the temperature of the gas sample; determining the concentration of water vapor in the dry combustion product produced from the lean combustion of the gas sample by the heated packed bed reactor; determining the oxygen gas concentration and carbon dioxide concentration in the lean combustion product; determining the local equivalence ratio and a global equivalence ratio from the oxygen gas concentration and carbon dioxide concentration in the lean combustion product; and determining a likelihood of backdraft in the enclosure from the oxygen gas concentration in the gas sample, the temperature of the gas sample, the concentration of water vapor in the dry combustion product, the oxygen gas concentration and carbon dioxide concentration in the lean combustion product, the local equivalence ratio and the global equivalence ratio. In an embodiment, the temperature of the gas sample is measured at a temperature sensor. In an embodiment, the oxygen concentration of the gas sample is measured at an oxygen sensor. In an embodiment, the carbon dioxide concentration of the gas sample is measured at a carbon dioxide sensor. In an embodiment, the flow rate of the gas sample is measured at a flow meter. In an embodiment, the excess oxidizer gas is communicated to the heated packed bed reactor of the phi meter. In an embodiment, the lean combustion product is produced from the lean combustion of the gas sample in the heated packed bed reactor of the phi meter. In an embodiment, the water vapor in the gas sample is condensed in a condenser. In an embodiment, the water vapor is removed from the lean combustion product in the condenser. In an embodiment, the dry combustion product is produced from the gas sample in the condenser.

In an embodiment, a user suspecting a backdraft or smoke explosion in an enclosure interfaces the backdraft determination apparatus to extract internal gas samples from the enclosure. A gas sample is extracted from enclosure 216 via a negative relative pressure generated by a vacuum pump. Flow is controlled and metered using the flow controlling unit and heated flow meter, respectively. The flow units are controlled and monitored via a control panel that receives and communicates a signal feed to the data acquisition system. The extracted gas sample is introduced into the phi meter includes an oxygen and temperature sensor at its inlet. The temperature and oxygen sensor outputs the temperature and oxygen concentration of the extracted gas to data acquisition system and control panel, allowing the user to view the data. The phi meter provides the global and local equivalence ratio and concentration of its reactor's combustion products to the data acquisition system and control panel, allowing the user to view the data. The measurements provided by the phi meter are used in a logistic regression model, which outputs a probability of a backdraft occurring in the enclosure of interest. The model is applied via the data acquisition system and the probability is expressed to the user via the control panel, at which point the user can evaluate the risk of entering the enclosure.

It is contemplated that backdraft determination apparatus 200 and determining a likelihood of a backdraft in an enclosure with backdraft determination apparatus 200 can include the properties, functionality, hardware, and process steps described herein and embodied in any of the following non-exhaustive list:
a process (e.g., a computer-implemented method including various steps; or a method carried out by a computer including various steps);
an apparatus, device, or system (e.g., a data processing apparatus, device, or system including means for carrying out such various steps of the process; a data processing apparatus, device, or system including means for carrying out various steps; a data processing apparatus, device, or system including a processor adapted to or configured to perform such various steps of the process);
a computer program product (e.g., a computer program product including instructions which, when the program is executed by a computer, cause the computer to carry out such various steps of the process; a computer program product including instructions which, when the program is executed by a computer, cause the computer to carry out various steps);
computer-readable storage medium or data carrier (e.g., a computer-readable storage medium including instructions which, when executed by a computer, cause the computer to carry out such various steps of the process; a computer-readable storage medium including instructions which, when executed by a computer, cause the computer to carry out various steps; a computer-readable data carrier having stored thereon the computer program product; a data carrier signal carrying the computer program product);
a computer program product including comprising instructions which, when the program is executed by a first computer, cause the first computer to encode data by performing certain steps and to transmit the encoded data to a second computer; or
a computer program product including instructions which, when the program is executed by a second computer, cause the second computer to receive encoded data from a first computer and decode the received data by performing certain steps.

Backdraft determination apparatus 200 has a number of benefits and advantages over conventional devices, including preventing backdraft conditions by monitoring enclosure 216 to detect a likelihood of backdraft. Backdraft determination apparatus 200 is more accurate than conventional devices because it uses a variety of sensors to gather data on the fire conditions, including the temperature, the oxygen level, and the carbon dioxide level that is used to calculate the backdraft risk with binary logistic regression model. Backdraft determination apparatus 200 reduces false alarms by using a machine learning model that filters out false alarms signals and patterns. Backdraft determination apparatus 200 can prevent backdrafts, mitigate fire and explosion conditions, and alert firefighters to the risk of backdraft. Backdraft determination apparatus 200 is easy to use, even for firefighters who are not familiar with backdraft detection. Backdraft determination apparatus 200 can be portable so it can be used in a variety of settings. Backdraft determination apparatus 200 is comparatively cost-effective and can save firefighters' time and resources by preventing false alarms and by helping to prevent backdrafts.

The articles and processes herein are illustrated further by the following Examples, which are non-limiting.

### EXAMPLES

### Example 1. A Binary Logistic Regression Model to Evaluate Backdraft Phenomenon

Predicting backdraft using a binary logistic regression model is presented. The model is established from time-averaged temperature, global and local equivalence ratios, and oxygen concentration measurements obtained in a series of backdraft experiments conducted at the National Fire Research Laboratory at the National Institute of Standards and Technology. The experiments utilized methane and propane fires of different sizes in a reduced-scale enclosure to create conditions conducive to a backdraft phenomenon. Time-averaged measurements estimated immediately before an anticipated backdraft were observed to vary with the duration of the total fuel flow time into the compartment. The established model's accuracy was found to improve with the inclusion of all time-averaged measurements as opposed to fewer components.

Backdraft experiments were conducted in a reduced-scale enclosure (1.0 m×1.0 m×1.5 m) ⅖^{th} the size of an ASTM fire test room dimensions. The enclosure's front has a centered, pneumatically operated door on a short wall with an approximately 43.0 cm wide and 80.0 cm high opening. A nominally 17.8 cm square sand burner's center is positioned approximately 1.25 m from the front opening of the compartment. Two spark igniters were used, either in the low or middle spark position, approximately 25.4 cm or 50.7 cm from the compartment floor.

Gas mixture composition measurements were examined at two locations within each experiment's compartment. Three sets of different locations were selected as positions of interest: one in the center of the upper (90.0 cm) and middle (49.5 cm) vertical layer of the compartment, another approximately 5 cm above (56.0 cm) and below (46.0 cm) the middle spark igniter, and another above (32.0 cm) and below (22.0 cm) the low spark igniter.

Extracted gas samples were portioned into a gas analyzer and phi meter. The gas analyzer includes a paramagnetic sensor to provide real-time O₂ concentration measurements. A chiller was positioned upstream of the gas analyzer to remove water vapor, indicating that all oxygen concentration measurements were obtained on a dry basis. A phi meter was implemented to evaluate the extracted gas sample's global and local equivalence ratios.

Temperature measurements were obtained across the various heights of the compartment opening using four 24.8 cm long Type K thermocouples positioned approximately 62.0 cm from the compartment opening. The heights of thermocouples span 19.7 cm to 79.4 cm from the compartment floor and are spaced approximately 19.9 cm apart. The temperature measurements are utilized to determine the temperature of an extracted gas sample via a linear regression fit at the corresponding height.

Backdraft experiments were initiated when the sand burner, fed fuel via mass flow controller, was ignited using a propane wand (t=0). Initially, the fire burns while the compartment doorway remains open for 60 s (t=60). After the front doorway was closed, fuel continued to be fed into the sand burner until a predetermined fuel flow time (FFT) was achieved (t=FFT). The flame was observed via borescope to extinguish at approximately 200 s from the ignition time, most likely due to limited ventilation. After the fuel flow time was achieved, the doorway remained closed for an additional 30 s, after which the doorway opened (t=FFT+30), and a backdraft was potentially observed.

Backdraft measurements generated from gaseous fuels were obtained from three controlled methane fires and three propane fires. A list of fuel flow times for each fire configuration is provided in Table 1. The uncertainty for all fire sizes was approximately 1.0 kW.

TABLE 1

| Fuel | Fire size (kW) | Fuel flow time (s) |
|---|---|---|
| Methane | 25.0 + 1.0 | 360, 390, 420, 450 |
| | 31.3 + 1.0 | 300, 360 |
| | 37.5 + 1.0 | 240, 270, 285, 300 |
| Propane | 16.7 + 1.0 | 270, 300, 315, 330 |
| | 20.9 + 1.0 | 210, 225, 240, 285 |
| | 25.0 + 1.0 | 240, 270, 285, 300 |

All temperature and gas mixture composition measurements are sampled at 1 Hz using a data acquisition system during an experiment. Measurements were averaged over a 10 s interval before the compartment doorway opening. The time-averaged measurement's combined uncertainty is estimated from a combination of the Type A and B evaluations of standard uncertainty.

As shown in Eq. 1, the binary logistic regression model uses time-averaged temperature, T̅, global equivalence ratio, φ̅_{G}, local equivalence ratio, φ̅_{L}, and oxygen concentration, X̅_{O}_{₂}, measurements of the extracted gas to output the likelihood of a backdraft, using a probability of 0.5 as the threshold.

$$p ( \overline{T} , {\overline{φ}}_{G} , {\overline{φ}}_{L} , {\overline{X}}_{{O}_{2}} ) = {[ 1 + {e}^{- ( {β}_{o} + {β}_{1} \overline{T} + {β}_{2} {\overline{φ}}_{G} + {β}_{3} {\overline{φ}}_{L} + {β}_{4} {\overline{X}}_{{O}_{2}} )} ]}^{- 1} ; \\ p ( \overline{T} , {\overline{φ}}_{G} , {\overline{φ}}_{L} , {\overline{X}}_{{O}_{2}} ) \geq 0.5 Backdraft \qquad ( 1 )$$

The model was established using a machine learning software package using R software. Compartment configurations (i.e., fuel, fire size, spark igniter location, etc.) are neglected since the model's purpose is to demonstrate an ability to predict backdraft without anticipating uncontrollable factors contributing to the phenomenon.

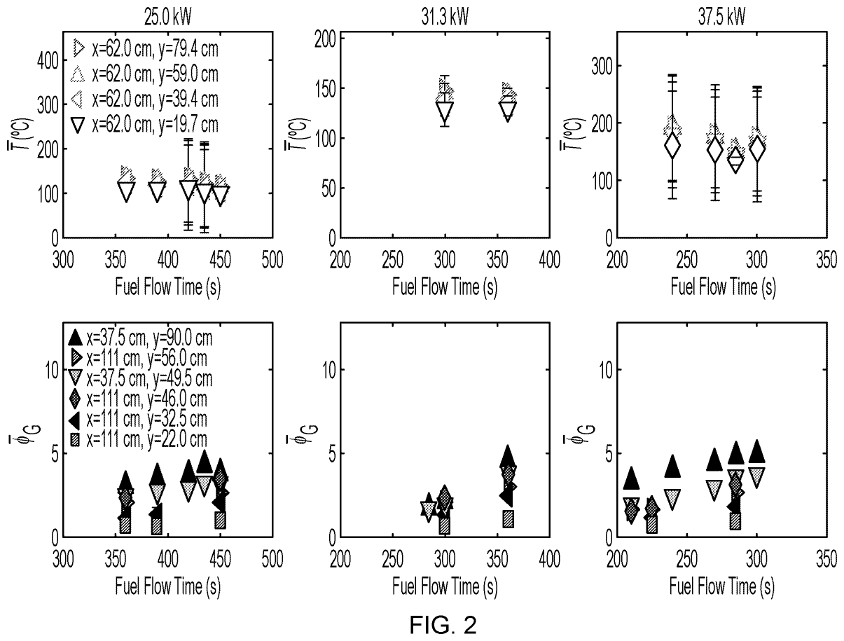

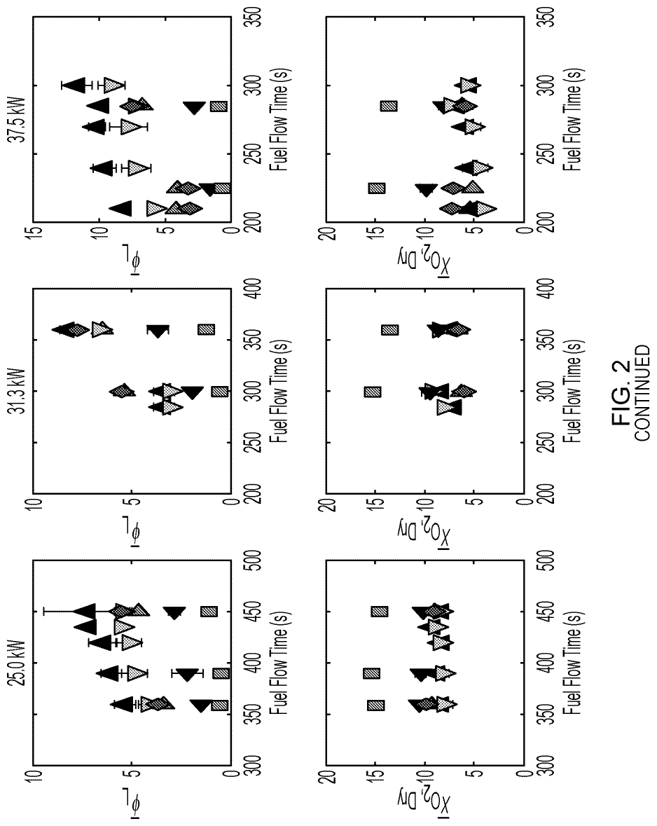

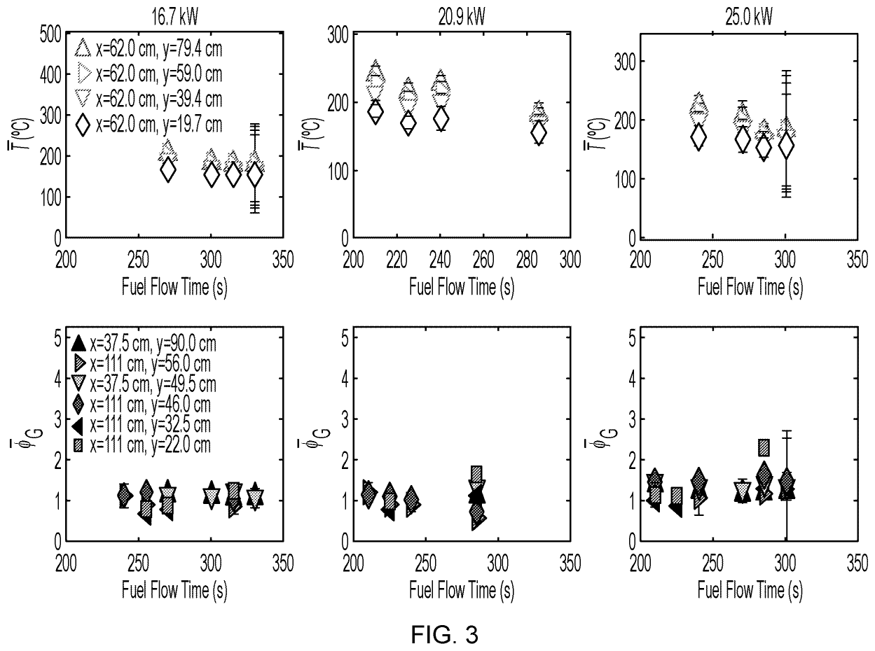

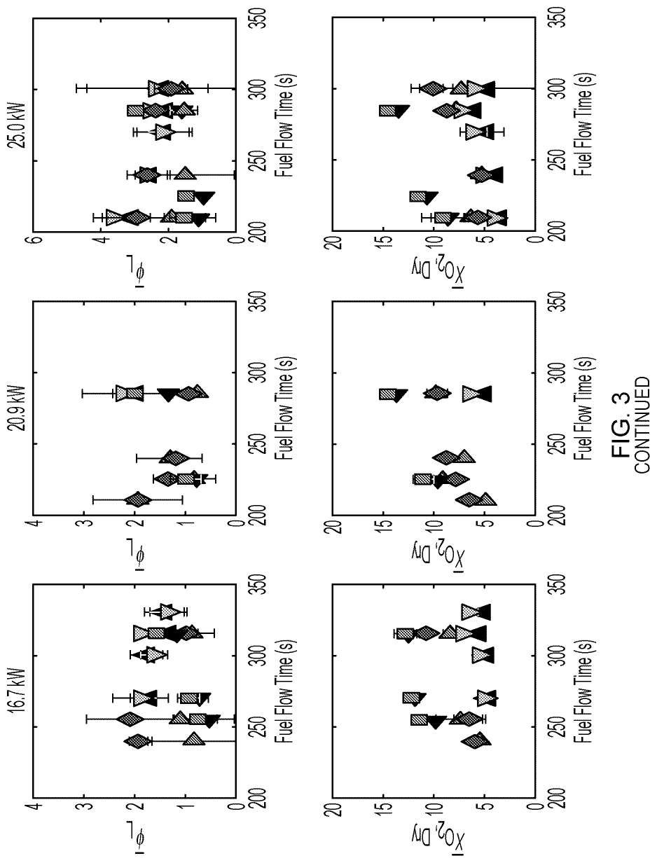

FIG. 2 and FIG. 3 show time-averaged temperature, global and local equivalence ratios, and oxygen concentration measurements for various sizes of methane and propane fires. When plotted as a function of fuel flow time for each fuel, the time-averaged temperature measurements are shown to decline. The decrease in temperature is most likely due to the increased duration between the flame extinguishing and door opening.

The time-averaged global and local equivalence ratios increase with fuel flow time in instances where the parent fuel is methane. The local equivalence ratio is fairly constant in the middle region of the compartment (approximately 50.0 cm from the compartment floor) for most methane fire configurations. Time-averaged oxygen concentration measurements are also nominally constant at different heights within the compartment for different fuel flow times, with the highest concentration observed at the lowest sampling position.

Contrary to methane experiments, the time-averaged global equivalence ratio measurements obtained in experiments with propane fires are lower and are observed to converge to an approximate value as the fuel flow time increases. The time-averaged local equivalence ratio measurements vary, suggesting that the fuel disperses throughout the compartment. The variation in the local equivalence ratio is further supported by the oxygen concentration measurements, which are also shown to vary at different heights within the compartment.

The time-averaged measurements were implemented in a binary logistic regression model, as shown in Eq. 1. When compared to the backdraft outcomes of the experimental dataset using a single-point reading, the model's accuracy was observed to correctly predict the potential for a backdraft in 70.8% of the total experiments. The model's accuracy is the sum of all true positive and negative predictions over the total number of experiments. Calculated probabilities in the model greater than 50% were designated backdraft events.

The model's accuracy was tested using a combination of measurements. Table 2 displays the model's accuracy as more measurements are included. Measurements selected for removal correspond to the absence of specific instrumentation. For example, the local equivalence ratio cannot be measured without knowing the oxygen concentration at the phi meter's inlet, which is obtained using an external gas analyzer. As fewer measurements are incorporated into the model, its accuracy decreases.

TABLE 2

| Global | | | Local | |
|---|---|---|---|---|
| Equiv. | Inlet | Inlet O₂ | Equiv. | |
| Ratio | Temperature | Concentration | Ratio | Accuracy |
| X | X | X | X | 70.8% |
| X | X | X | | 70.5% |
| X | X | | | 29.4% |
| X | | | | 29.4% |

The model with all components was re-evaluated by incorporating two measurements obtained at different positions. When compared to the backdraft outcomes of the experimental dataset, the two-point model's accuracy was observed to correctly predict the potential for a backdraft in 82.4% of all cases. The greater accuracy of the two-point model indicates that the backdraft evaluation system is improved by increasing the number of sampling positions at various heights within the enclosed structure.

This Example describes a binary logistic regression model that uses temperature and gas mixture composition measurements to predict the likelihood of backdraft, as implemented with a phi meter that evaluates global and local equivalence ratios with oxygen concentration and temperature measurements of the extracted gas. The model demonstrated 70.8% accuracy with all measurements incorporated from a single sampling position. The model's accuracy was observed to decline with the absence of measurements. The method described herein demonstrates a quantifiable technique that predicts backdraft and provides firefighters with a way to reduce the risk.

### Example 2

A backdraft determination apparatus was used in backdraft experiments conducted at NIST's National Fire Research Laboratory. The experiments used a reduced-scale enclosure (1.0 m×1.0 m×1.5 m), ⅖th the dimensions of the ASTM fire test room. The enclosure's front has a pneumatically operated door located along a short wall with a 43.0 cm wide and 80.0 cm high opening. Backdraft experiments were initiated when a small sand burner, fed fuel via mass flow controller, was ignited using a propane wand (t=0). Initially, the fire burns while the compartment doorway remains open for 60 s (t=60). After the front doorway is closed, fuel continues to be fed into the sand burner until a predetermined fuel flow time is achieved. The doorway remains closed for an additional 30 s, after which the doorway opens, and a potential backdraft is observed. Fuels of interest included gaseous fuels (i.e., propane and propylene) and a medium-density fiberboard crib. In experiments with solid fuels, the crib was allowed to burn for approximately 12 min. to achieve a relatively steady fire size. Overall, 145 experiments were conducted using different compartment configurations that modified the opening size, spark location, fire size, and burning time while the compartment remained isolated. During each experiment, two enhanced phi meters continuously extracted gas samples 90.0 cm and 49.5 cm from the compartment floor. Each enhanced phi meter provided real-time measurements throughout the experiment. The enhanced phi meters' datasets were averaged over a 10 s interval prior to compartment opening to generate a dataset representing pre-backdraft conditions prior. The average dataset generated from the experimental series was then used to develop a predictive model for a backdraft in the enclosure. The model10incorporated all measurements recorded by the enhanced phi meter. Compartment configurations were neglected since the model's purpose was to demonstrate an ability to predict backdraft without using prior knowledge of burning conditions while the door remained closed. When compared to the backdraft outcomes of the experimental dataset using a single-point reading, the model's accuracy was observed to correctly predict the potential for a backdraft in 76.6% of the total cases. The model's accuracy is the sum of all true positive and true negative predictions over the total number of cases. In the model, calculated probabilities greater than 50% were designated as backdraft events. The model's accuracy was tested using a combination of parameters representing various configurations of the enhanced phi meter's design. As more components are removed from the enhanced phi meter design, fewer parameters are included, and the model's accuracy decreases. The model with all components was re-evaluated by incorporating simultaneous measurements recorded at 90.0 cm and 49.5 cm from the compartment floor. When compared to the backdraft outcomes of the experimental dataset, the two-point model's accuracy was observed to correctly predict the potential for a backdraft in 89.7% of all cases. The greater accuracy of the two-point model indicates that the backdraft evaluation apparatus is improved by increasing the number of sampling positions at various heights within the enclosed structure.

The processes described herein may be embodied in, and fully automated via, software code modules executed by a computing system that includes one or more general purpose computers or processors. The code modules may be stored in any type of non-transitory computer-readable medium or other computer storage device. Some or all the methods may alternatively be embodied in specialized computer hardware. In addition, the components referred to herein may be implemented in hardware, software, firmware, or a combination thereof.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

Any logical blocks, modules, and algorithm elements described or used in connection with the embodiments disclosed herein can be implemented as electronic hardware, computer software, or combinations of both. To clearly illustrate this interchangeability of hardware and software, various illustrative components, blocks, modules, and elements have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described or used in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix(s) as used herein is intended to include both the singular and the plural of the term that it modifies, thereby including at least one of that term (e.g., the colorant(s) includes at least one colorants). Option, optional, or optionally means that the subsequently described event or circumstance can or cannot occur, and that the description includes instances where the event occurs and instances where it does not. As used herein, combination is inclusive of blends, mixtures, alloys, reaction products, collection of elements, and the like.

As used herein, a combination thereof refers to a combination comprising at least one of the named constituents, components, compounds, or elements, optionally together with one or more of the same class of constituents, components, compounds, or elements.

All references are incorporated herein by reference.

The use of the terms “a,” “an,” and “the” and similar referents in the context of describing the invention (especially in the context of the following claims) are to be construed to cover both the singular and the plural, unless otherwise indicated herein or clearly contradicted by context. It can further be noted that the terms first, second, primary, secondary, and the like herein do not denote any order, quantity, or importance, but rather are used to distinguish one element from another. It will also be understood that, although the terms first, second, etc. are, in some instances, used herein to describe various elements, these elements should not be limited by these terms. For example, a first current could be termed a second current, and, similarly, a second current could be termed a first current, without departing from the scope of the various described embodiments. The first current and the second current are both currents, but they are not the same condition unless explicitly stated as such.

The modifier about used in connection with a quantity is inclusive of the stated value and has the meaning dictated by the context (e.g., it includes the degree of error associated with measurement of the particular quantity). The conjunction or is used to link objects of a list or alternatives and is not disjunctive; rather the elements can be used separately or can be combined together under appropriate circumstances.

### PARTS LIST

backdraft determination apparatus 200
phi meter 201
heated packed bed reactor 202
oxygen sensor 203
temperature sensor 204
excess oxygen supply 205
heated flow meter 206
condenser 207
flow control unit 208
vacuum pump 209
gas analyzer 210
backdraft analyzer unit 211
control unit 212
heated flow meter signal 213
backdraft threshold 214
gas sample 215
enclosure 216
lean combustion product 217
excess oxidizer gas 218
gas sampling line 219
catalyst 220
heating element 221
oxygen sensor signal 222
temperature sensor signal 223
dry combustion product 224
outlet 225
flow control unit signal 226
gas analyzer signal 227
binary logistic regression model 228
determining a likelihood of a backdraft in an enclosure//determines a likelihood of a backdraft in an enclosure

1. A backdraft determination apparatus for determining a likelihood of a backdraft in an enclosure from a gas sample, the backdraft determination apparatus comprising:
a phi meter comprising a heated packed bed reactor and that receives the gas sample from the enclosure and measures a temperature, an oxygen concentration, a carbon dioxide concentration, and a flow rate of a gas sample;
the heated packed bed reactor disposed in the phi meter and in fluid communication with the enclosure and in fluid communication with an excess oxygen supply and that receives the gas sample from the enclosure, receives an excess oxidizer gas from the excess oxygen supply, performs lean catalyst combustion of the gas sample in the presence of the excess oxidizer gas, and produces a lean combustion product from the lean combustion of the gas sample;
the excess oxygen supply in fluid communication with the heated packed bed reactor and that communicates the excess oxidizer gas to the heated packed bed reactor;
a condenser in fluid communication with the heated packed bed reactor and in fluid communication with a flow meter and that receives the gas sample from the heated packed bed reactor, condenses water vapor in the gas sample, removes the water vapor from the gas sample, produces a dry combustion product from the gas sample, and communicates the dry combustion product to a flow control unit;
a flow control unit in fluid communication with the condenser and in fluid communication with a vacuum pump and that receives the dry combustion product from the condenser, regulates flow through the phi meter, and communicates the dry combustion product to the vacuum pump;
a vacuum pump in fluid communication with the flow control unit and in fluid communication with a gas analyzer and that receives the dry combustion product from the flow control unit and fluidically drives flow of the gas sample into the heated packed bed reactor of the phi meter;
a gas analyzer in fluid communication with the vacuum pump and in electrical communication with a backdraft analyzer unit and that receives the dry combustion product from the vacuum pump, measures an oxygen gas concentration and a carbon dioxide concentration in the dry combustion product, produces a gas analyzer signal that indicates the oxygen gas concentration and the carbon dioxide concentration in the dry combustion product, and communicates the dry combustion product to the backdraft analyzer unit;
the backdraft analyzer unit that receives an oxygen sensor signal from an oxygen sensor, receives a temperature sensor signal from a temperature sensor, receives a heated flow meter signal from a heated flow meter, receives a flow control unit signal from the flow control unit, receives the gas analyzer signal from the gas analyzer, determines the oxygen gas concentration in the gas sample from the oxygen sensor signal, determines a local equivalence ratio of the gas sample from the oxygen sensor signal, determines the temperature of the gas sample from the temperature sensor signal, determines the concentration of water vapor in the dry combustion product produced from the lean combustion of the gas sample by the heated packed bed reactor from the heated flow meter signal and the flow control unit signal, determines the oxygen gas concentration and the carbon dioxide concentration in the lean combustion product from the gas analyzer signal, determines the local equivalence ratio and a global equivalence ratio from the oxygen gas concentration and the carbon dioxide concentration in the lean combustion product, and determines a likelihood of backdraft in the enclosure from the oxygen gas concentration in the gas sample, the temperature of the gas sample, the concentration of water vapor in the dry combustion product, the oxygen gas concentration and the carbon dioxide concentration in the lean combustion product, and the local equivalence ratio and the global equivalence ratio to determine the likelihood of backdraft in the enclosure from the gas sample.

2. The backdraft determination apparatus of claim 1, further comprising: an oxygen sensor disposed in the phi meter and in fluid communication with the heated packed bed reactor and in electrical communication with the backdraft analyzer unit and that receives the gas sample from the enclosure, senses a concentration of oxygen gas in the gas sample received by the heated packed bed reactor, produces an oxygen sensor signal that indicates the concentration of oxygen gas in the gas sample, and communicates the oxygen sensor signal to the backdraft analyzer unit.

3. The backdraft determination apparatus of claim 1, further comprising: a temperature sensor disposed in the phi meter and in thermal communication with the gas sample and in electrical communication with the backdraft analyzer unit and that senses a temperature of the gas sample received by the heated packed bed reactor, produces a temperature sensor signal that indicates the temperature of the gas sample, and communicates the temperature sensor signal to the backdraft analyzer unit.

4. The backdraft determination apparatus of claim 1, further comprising: a heated flow meter in fluid communication with the heated packed bed reactor and in fluid communication with the condenser and in electrical communication with the backdraft analyzer unit and that receives the lean combustion product from the heated packed bed reactor, measures a total flow of the lean combustion product from the heated packed bed reactor, produces a heated flow meter signal that indicates the total flow of the lean combustion product, and communicates the heated flow meter signal to the backdraft analyzer unit.

5. The backdraft determination apparatus of claim 1, further comprising: a control unit in electrical communication with the oxygen sensor and in electrical communication with the temperature sensor and in electrical communication with the backdraft analyzer unit and in electrical communication with the heated flow meter and in electrical communication with the flow control unit and that controls operation of the oxygen sensor, the temperature sensor, the backdraft analyzer unit, the heated flow meter, and the flow control unit.

6. The backdraft determination apparatus of claim 1, further comprising: the enclosure in fluid communication with the heated packed bed reactor and in fluid communication with the oxygen sensor and in thermal communication with the temperature sensor and that comprises a gas sample and communicates the gas sample to the heated packed bed reactor.

7. The backdraft determination apparatus of claim 1, further comprising: a gas sampling line in fluid communication with the enclosure and in fluid communication with the heated packed bed reactor and in fluid communication with the oxygen sensor and that communicates the gas sample from the enclosure to the heated packed bed reactor and to the oxygen sensor.

8. The backdraft determination apparatus of claim 1, further comprising:
a catalyst disposed in the heated packed bed reactor and that assists in the complete combustion of the gas sample that comprises a fuel; and
a heating element disposed in the heated packed bed reactor and disposed on the catalyst and in thermal communication with the catalyst and that elevates the temperature of the catalyst such that complete lean combustion of the gas sample occurs by the heated packed bed reactor.

9. The backdraft determination apparatus of claim 1, further comprising: an outlet disposed on the phi meter and in fluid communication with the heated packed bed reactor and in fluid communication with the heated flow meter and that communicates the lean combustion product from the heated packed bed reactor to the heated flow meter.

10. The backdraft determination apparatus of claim 1, wherein the backdraft threshold is determined according to a binary logistic regression model that includes a time-averaged temperature, T̅, a global equivalence ratio, φ̅_{G}, a local equivalence ratio, φ̅_{L}, and an oxygen concentration, X̅ₒ_{₂}, and measurements of the lean combustion product.

11. The backdraft determination apparatus of claim 10, further wherein the binary logistic regression model includes a machine learning model to predict backdraft of the enclosure.

12. A process for determining a likelihood of a backdraft in an enclosure with a backdraft determination apparatus, the process comprising:
receiving a gas sample from the enclosure;
measuring the temperature, oxygen concentration, carbon dioxide concentration, and flow rate of the gas sample;
performing lean catalyst combustion of the gas sample in presence of an excess oxidizer gas;
condensing water vapor in the gas sample and removing water vapor from the gas sample;
regulating flow through a phi meter;
fluidically driving flow of the gas sample into the heated packed bed reactor of the phi meter;
measuring the oxygen gas concentration and carbon dioxide concentration in the dry combustion product;
determining the oxygen gas concentration in the gas sample;
determining a local equivalence ratio of the gas sample;
determining the temperature of the gas sample;
determining the concentration of water vapor in the dry combustion product produced from the lean combustion of the gas sample by the heated packed bed reactor;
determining the oxygen gas concentration and carbon dioxide concentration in the lean combustion product;
determining the local equivalence ratio and a global equivalence ratio from the oxygen gas concentration and carbon dioxide concentration in the lean combustion product; and
determining a likelihood of backdraft in the enclosure from the oxygen gas concentration in the gas sample, the temperature of the gas sample, the concentration of water vapor in the dry combustion product, the oxygen gas concentration and carbon dioxide concentration in the lean combustion product, a local equivalence ratio and a global equivalence ratio.

13. The process of claim 12, wherein the temperature of the gas sample is measured at a temperature sensor.

14. The method of claim 12, wherein the oxygen concentration of the gas sample is measured at an oxygen sensor.

15. The method of claim 12, wherein the carbon dioxide concentration of the gas sample is measured at a carbon dioxide sensor.

16. The method of claim 12, wherein the flow rate of the gas sample is measured at a flow meter.

17. The method of claim 12, wherein the excess oxidizer gas is communicated to the heated packed bed reactor of the phi meter.

18. The method of claim 12, wherein the lean combustion product is produced from the lean combustion of the gas sample in the heated packed bed reactor of the phi meter.

19. The method of claim 12, wherein the water vapor in the gas sample is condensed in a condenser.

20. The method of claim 19, wherein the water vapor is removed from the lean combustion product in the condenser.

21. The method of claim 12, wherein the dry combustion product is produced from the gas sample in the condenser.
